(19) United States
(12) Patent Application Publication
(10) Pub. No.: US 2007/0096458 A1
(43) Pub. Date: May 3, 2007

(54) Exhaust Pipe for a Flat Lamp

(75) Inventors: Jer-Shien Yang, Taipei County (TW); Kuo-Chih Yang, Hsinchu City (TW); Shih-Yuan Huang, Taichung County (TW)

Correspondence Address: WPAT, PC;INTELLECTUAL PROPERTY ATTORNEYS, 2030 MAIN STREET, SUITE 1300, IRVINE, CA, 92614, US

(73) Assignee: DELTA OPTOELECTRONICS, INC., Hsin-Chu (TW)

(21) Appl. No.: 11/552,937

(22) Filed: Oct. 25, 2006

(30) Foreign Application Priority Data
Oct. 28, 2005 (TW) 094137946

(51) Int. Cl. F16L 17/00

(52) U.S. Cl. 285/102

(57) ABSTRACT

An exhaust pipe being applied in a flat lamp is disclosed, which is comprised of an inner tube and an outer tube and is being arranged at a side of the flat lamp for pumping/exhausting gas therein/therefrom. The inner tube is fitted to a side of the flat lamp while enabling the same to be in communication with the discharge space of the flat lamp; and the outer tube, which is further in communication with the inner tube, is connected to a pumping/exhausting device. After performing a pumping/exhausting process upon the flat lamp by way of the exhaust pipe attached thereto, the exhaust pipe is fused to seal the flat lamp. Moreover, the residue of the fused exhaust pipe attached on the flat lamp will not cause the thickness of the flat lamp to increase, and the exhaust pipe of the invention will help to increase the mechanism strength at the joint of the exhaust pipe and the flat lamp.

### FIELD OF THE INVENTION

The present invention relates to an exhaust pipe, and more particularly, to an exhaust pipe being adapted as an interface of pumping/exhausting gas into/out of a flat lamp therethrough, whereas the flat lamp is serving as a back light of liquid crystal display.

### BACKGROUND OF THE INVENTION

In the recent information oriented society, importance of visual display devices has increased. Requirements for large-sized display devices having low power consumption, thin thickness, light weight and high picture quality have to be satisfied. Because of the maturity of liquid crystal display (LCD) technology, the characteristics of LCD devices are capable of satisfying all those conditions and are suitable for mass-production and thus various new LCD products have been rapidly developed. Among those LCD devices, LCD TV is considered to be the star display device for the future digital TV system.

LCDs are nonemissive light devices, which means they do not produce any form of light. Instead they block/pass light reflected from an external light source provided by a back light module. Currently, it is common to use a back light module with multiple thin cold cathode lamps as the light source of illumination to give the display sufficient contrast and brightness and thus satisfy the demands of high brightness LCDs. However, in order to providing uniform illumination across the LCD surface and luminance that is high enough to produce good contrast in a day environment, the back light module with multiple thin cold cathode lamps must have a diffuser that is thick enough to takes the numerous points of light and uniformly spreads it out over the entire area of the display. Moreover, the brightness decay of each cold cathode lamp is speeding up after long-hour operation while the speed of the decaying is varied from one cold cathode lamp to another that it is common for a large-sized high brightness LCD to suffer the phenomenon of uneven illumination. Therefore, flat fluorescent lamps become a preferred option to be used as the back light of liquid crystal display.

Please refer to FIG. 1, which is an exposed perspective view of lo a flat lamp disclosed in U.S. Pat. No. 4,920,298. As seen in FIG. 1, the flat lamp 1 is substantially a flat fluorescent lamp, which is primarily comprised of an upper glass plate 13, a lower glass plate 14, a first side frame 11, a second side frame 12, Phosphors and electrodes. Since the lighting of the flat fluorescent lamp 1 is caused by the principle of gas discharging, it is required to fill the lamp 1 with an inert gas and thus a process of gas pumping/exhausting is required for the manufacturing of the lamp 1. The flat fluorescent lamp 1 is produced by removing air from the interior of the lamp through the tip tube 15 and then introducing an inert gas into the same through the tube 15 and sealing off the outer end of the tip tube 15 by fusion. In FIG. 1, the tip tube 15 is fitted in the cutout 121 formed on the second side frame 12.

Although the tip tube 15 is being fitted on the cutout 121 of the second side frame, it is noted that the thickness of the flat lamp 1 will not be increased thereby. Nevertheless, since the outer end of the tip tube 15 is not specially designed for the fused-to-seal process and the glass wall of the tip tube 15 is thin as the diameter of the tip tube 15 is enlarged as much as possible for the maximum flux, the condition that a portion of the glass wall of the tip tube 15 is melt while another portion is not will be caused as the tip tube is being fused at an improper position or the temperature control of the fuse-to-seal process is not appropriate. The aforesaid partial melting condition of the tip tube 15 is going to cause the leakage of the lamp 1 or enable outeside air to enter the lamp, in which case, the illuminating quality of the lamp 1 is adversely affect. In addition, since the overall tube diameter of the tip tube 15 is approximately equal to the thickness of the second glass side frame 12 of the lamp 1 while the thickness of the flat lamp 1 should be very small to be used as the back light of LCDs, the overall tube diameter of the tip tube 15 is even smaller that cause the mechanical strength of the tip tube 15 to be relatively weak and thus the tip tube 15 is prone to be break during the pumping/exhausting process.

Therefore, it is in great need to have an improved exhaust pipe that is free from the foregoing problems.

### SUMMARY OF THE INVENTION

The primary object of the invention is to provide an exhaust pipe for a flat lamp to be adapted as an interface of pumping/exhausting gas into/out of the flat lamp therethrough, in that the exhaust pipe is composed of tubes of different diameters for enhancing the mechanism strength at the joint of the exhaust pipe and the flat lamp.

It is another object of the invention to provide an exhaust pipe for a flat lamp capable of reducing the leakage of the flat lamp caused by the exhausting pipe being fused to seal partially, in that the exhaust pipe has a neck arranged at a position of the exhaust pipe specified for sealing the same by fusion and the diameter of the neck is shrunk for enabling the same to be smaller than that of the exhaust tube.

To achieve the above objects, the present invention provides an exhaust pipe, being adapted to be arranged at a side of a flat lamp for pumping/exhausting gas therein/therefrom, which comprises: an inner tube, fitted to a side frame of the flat lamp while enabling the same to be in communication with a discharge space formed inside the flat lamp; and an outer tube, being adapted to communicated with the inner tube while being connected to a pumping/exhausting device.

In a preferred embodiment of the invention, a notch is formed on the side frame of the flat lamp for insetting the inner tube, wherein a portion of the inset inner tube is protruding out of the side frame by a length ranged between 3 mm to 5 mm as the length of the protruding portion of the inner tube is smaller than that of the portion of the inner tube insetting in the notch.

Preferably, the external diameter of the inner tube is smaller than the thickness of the side frame.

Preferably, the outer tube is arranged to ensheathe the inner tube, and the internal diameter of the outer tube is larger than the external diameter of the inner tube by 0.3 mm.

Preferably, the outer tube has a tapered joint arranged at an end thereof to be used for connecting the same to the inner tube, and the outer tube and the inner tube can be integrally formed.

Preferably, the inner tube is a round-shaped tube.

In another preferred embodiment of the invention, the inner tube further comprises a square head to be fitted and embedded into a notch formed in the side frame of the flat lamp.

Preferably, a neck is formed on the outer tube at a position proximate to the square head of the inner tube.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an exposed perspective view of a flat lamp disclosed in U.S. Pat. No. 4,920,298.

FIG. 2A is a top view of an exhaust pipe adapted for a flat lamp according to a first preferred embodiment of the invention.

FIG. 2 is a side view of an exhaust pipe adapted for a flat lamp according to a first preferred embodiment of the invention.

FIG. 3 is a top view of an exhaust pipe adapted for a flat lamp according to a second preferred embodiment of the invention.

FIG. 4A is a top view of an exhaust pipe adapted for a flat lamp according to a third preferred embodiment of the invention.

FIG. 4B is a side view of an exhaust pipe adapted for a flat lamp according to a first preferred embodiment of the invention.

FIG. 5A is a schematic diagram showing an exhaust pipe with shrinking neck according to the present invention.

FIG. 5B is a schematic diagram showing another exhaust pipe with shrinking neck according to the present invention.

FIG. 5C is a schematic diagram showing yet another exhaust pipe with shrinking neck according to the present invention.

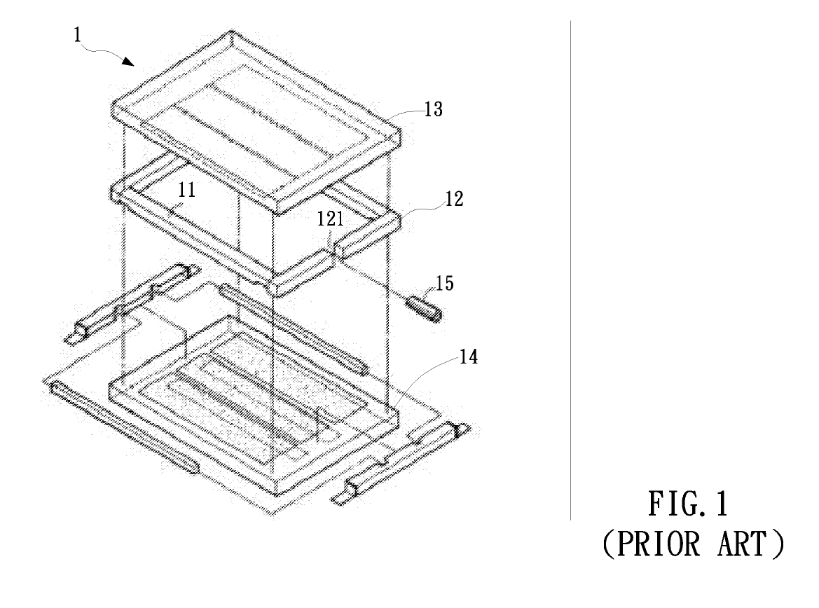

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

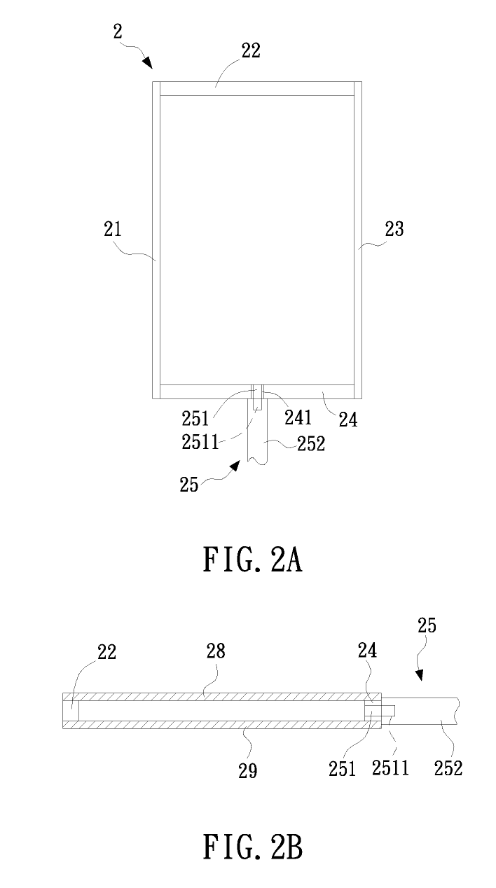

Please refer to FIG. 2A and FIG. 2B, which are respectively a top view and a side view of an exhaust pipe adapted for a flat lamp according to a first preferred embodiment of the invention. As seen, the flat lamp 2 is comprised of four side frames 21, 22, 23, 24, a top glass plate 28 and a bottom glass plate 29. Wherein, the four side frames 21, 22, 23, 24 are bonded to the peripheral edges of the top and bottom glass plates 28, 29 while being sandwiched thereby, by which the formation of the four side frames 21, 22, 23, 24, forms the side wall of the flat lamp.

In FIG. 2A and FIG. 2B, an exhaust pipe 25 is adapted to be arranged at a side of the flat lamp 2 an is in communication with an discharge space formed inside the flat lamp 2. The exhaust pipe 25 comprises: an inner tube 251, fitted to a notch 241 formed on the side frame 24 of the flat lamp 2 while enabling the same to be in communication with the discharge space of the flat lamp 2; and an outer tube 252, being adapted to communicated with the inner tube 251; wherein the diameter of the outer tube 252 is larger than that of the inner tube 251. Moreover, the gap that is formed as the inner tube 251 being fitted into the notch 241 can be filled by a glass paste for ensuring airtight during pumping/exhausting gas into/out of the flat lamp 2 through the exhaust pipe 25 so as to prevent leakage.

Furthermore, a portion 2511 of the inset inner 251 tube is protruding out of the side frame 24 and the external diameter of the inner tube 251 is smaller than the internal diameter of the outer tube 252 so that the mechanism strength at the joint of the exhaust pipe 25 and the flat lamp 2 can be enhanced by ensheathing the outer tube 252 onto the protruding portion 2511 of the inner tube 251. It is noted that the external diameter of the outer tube 252 should not exceed the overall thickness of the flat lamp 2, i.e. the total thickness including those of the top plate 28, the bottom plate 29 and the side frames. In this first preferred embodiment of the invention, the internal diameter of the outer tube 252 is larger than the external diameter of the inner tube 251 by about 0.3 mm, however, the difference between the two being 0.3 mm is preferred but not limited by thereby. In order to enhance airtight while preventing leakage, it is preferred to have the external diameter of the outer tube 252 to be small than the thickness of the side frame 24. Yet, the length of the protruding portion 2511 of the inner tube 251 is preferred to be in the range of 3 mm to 5 mm, that is, if the protruding portion 2511 is too short, not only the outer tube 252 is difficult to ensheathe and fix itself onto the inner tube 251, but also the mechanism strength at the joint can not be enhanced as preferred; and if the protruding portion 2511 is too long, not only will cause trouble while ensheathing the inner tube 251 by the outer tube 252, but also the inner tube 251 is ease to be break during the ensheathing process. Moreover, the length of the protruding portion 2511 of the inner tube 251 should be smaller than that of the portion of the inner tube 251 insetting in the notch 241, otherwise, the inner tube 251 might be tilted by instable median point thereof during the manufacturing of the flat lamp 2. In addition, the length of the portion of the inner tube 251 insetting in the notch 24 should not larger than the width of the side frame 24, otherwise, the insetting portion of the inner tube will invade the illuminating area of the flat lamp 2 and thus cause unwanted shadows.

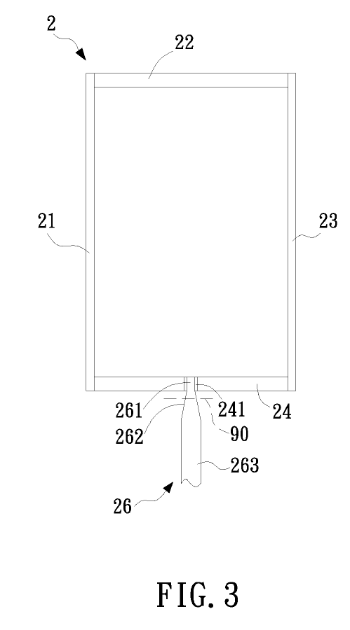

Please refer to FIG. 3, which a top view of an exhaust pipe adapted for a flat lamp according to a second preferred embodiment of the invention. The integrally formed exhaust pipe 26 of FIG. 3 is also capable of being fitting to a side of a flat lamp 2, and further it is not going to cause the overall thickness of the flat lamp to increase after the integrally formed exhaust pipe 26 is fused to seal the flat lamp 2. In FIG. 3, the outer tube 263 has a tapered joint 262 arranged at an end thereof to be used for connecting the same to the inner tube 261 fitted in the notch 241, and the outer tube 263 and the inner tube 261 can be integrally formed. The advantage of the exhaust pipe 26 of FIG. 3 is that the portion of the exhaust pipe 26 resides and remains in the flat lamp 2 is comparatively smaller after it is being fused to seal the lamp 2 and it is preferably to be fused at the position marked by the dotted line 90 shown in FIG. 3. However, it is also because of the tube diameter of the exhaust pipe 26 is tapered at the joint of the exhaust pipe 26 and the flat lamp 2, the mechanical strength of the joint is weakened so that the exhaust pipe is easy to break as it is being used to pump/exhaust gas into/out of a large-sized flat lamp. Therefore, the exhaust pipe 26 of FIG. 3 is suitable to be used for smaller flat lamps.

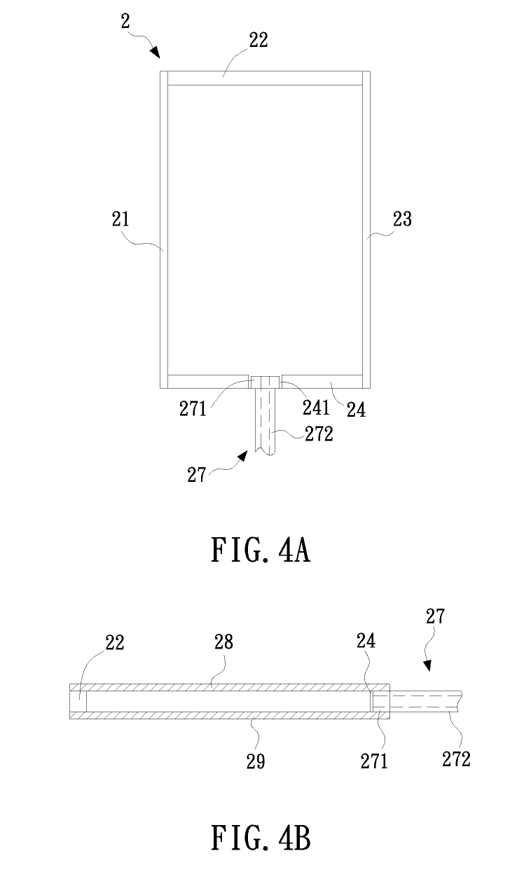

Please refer to FIG. 4A and FIG. 4B, which are respectively a top view and a side view of an exhaust pipe adapted for a flat lamp according to a third preferred embodiment of the invention. The exhaust pipe 27 in this embodiment is integrally formed, whereas the inner tube thereof 271 further comprises a square head to be fitted and embedded into a notch 241 formed in the side frame 24 of the flat lamp 2, and the square head is channeled at the center thereof to be in communication with the outer tube 272 of the exhaust pipe 27. It is preferred that the thickness of the square head is the same as that of the side frame 24. The exhaust pipe 27 of this embodiment can help to improve the sealing of the flat lamp 2 since the notch 241 formed is usually a square that can match with the square head of the inner tube 271 and thus the gap formed around the notch 24 and the square hand is smaller to be seal by a small amount of glass paste.

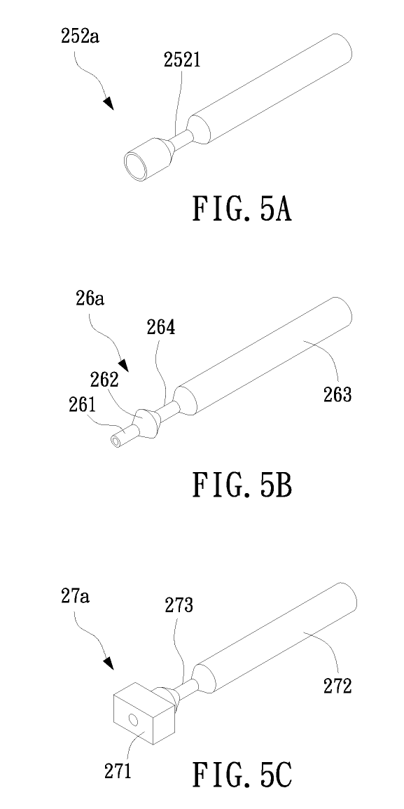

Since the aforesaid tip tube is not specially designed for the fused-to-seal process and the glass wall of the outer tube is comparatively thinner as the diameter of the outer tube is enlarged as much as possible for the maximum flux, the condition that a portion of the glass wall of the outer tube is melt while another portion is not will be caused as the outer tube is being fused at an improper position or the temperature control of the fuse-to-seal process is not appropriate. The aforesaid partial melting condition of the outer tube is going to cause the leakage of the lamp or enable outside air to enter the lamp, in which case, the illuminating quality of the lamp is adversely affect. Therefore, it is intended to design the outer tube of an exhaust pipe specifically for the problem. Please refer to FIG. 5A, which is a schematic diagram showing an exhaust pipe with shrinking neck according to the present invention. The outer tube 252a of the exhaust pipe shown in FIG. 5A has a neck 2521 being arranged at a position to be fused. It is noted that the diameter of the outer tube 252a is shrunken at the neck portion thereof so that the fuse-to-seal process is easier to be perform at the neck without causing leakage. In FIG. 5C, the tapered outer tube similar to that shown in FIG. 3 also are formed with a neck 264. In FIG. 5C, a neck 273 is formed on the outer tube of an exhaust pipe similar to that shown in FIG. 4A.

To sum up, it is noted that the residue of the fused exhaust pipe attached on the flat lamp will not cause the thickness of the flat lamp to increase, and the design of the exhaust pipe of the invention will help to increase the mechanism strength at the joint of the exhaust pipe and the flat lamp.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An exhaust pipe, being adapted to be arranged at a side of a flat lamp for pumping/exhausting gas therein/therefrom, the exhaust pipe comprising:
an inner tube, fitted to a side frame of the flat lamp while enabling the same to be in communication with a discharge space formed inside the flat lamp; and
an outer tube, being adapted to communicated with the inner tube while being connected to a pumping/exhausting device.

2. The exhaust pipe of claim 1, a notch is formed on the side frame of the flat lamp for insetting the inner tube.

3. The exhaust pipe of claim 2, wherein a portion of the inset inner tube is protruding out of the side frame.

4. The exhaust pipe of claim 3, wherein the length of the protruding portion of the inner tube is ranged between 3 mm to 5 mm.

5. The exhaust pipe of claim 3, wherein the length of the protruding portion of the inner tube is smaller that that of the portion of the inner tube insetting in the notch.

6. The exhaust pipe of claim 2, wherein the inner tube further comprises a square head to be fitted and embedded into a notch formed in the side frame of the flat lamp.

7. The exhaust pipe of claim 6, wherein the inner tube is connected to the outer tube.

8. The exhaust pipe of claim 1, wherein the external diameter of the inner tube is smaller than the thickness of the side frame.

9. The exhaust pipe of claim 1, wherein the outer tube is arranged to ensheathe the inner tube.

10. The exhaust pipe of claim 9, wherein the internal diameter of the outer tube is larger than the external diameter of the inner tube by 0.3 mm.

11. The exhaust pipe of claim 1, wherein the external diameter of the outer tube is small than the overall thickness of the flat lamp.

12. The exhaust pipe of claim 1, wherein the outer tube has a tapered joint arranged at an end thereof to be used for connecting the same to the inner tube.

13. The exhaust pipe of claim 12, wherein the outer tube and the inner tube are integrally formed.

14. The exhaust pipe of claim 1, the inner tube is a round-shaped tube.

15. The exhaust pipe of claim 1, wherein a neck is formed on the outer tube at a position proximate to the inner tube.
